(19) United States
(12) Patent Application Publication
(10) Pub. No.: US 2005/0280658 A1
(43) Pub. Date: Dec. 22, 2005

(54) Method of accurate fixed-point line clipping

(76) Inventor: Aleksandar Filipov, Malmo (SE)

Correspondence Address: ERICSSON INC., 6300 LEGACY DRIVE, M/S EVR C11, PLANO, TX, 75024, US

(21) Appl. No.: 11/015,425

(22) Filed: Dec. 17, 2004

Related U.S. Application Data
(60) Provisional application No. 60/582,244, filed on Jun. 22, 2004.

(51) Int. Cl. G09G 5/00

(52) U.S. Cl. 345/620

(57) ABSTRACT

A line-clipping method includes determining whether a fixed-point-arithmetic line-clipping operation would likely be inaccurate due to limitations of fixed-point arithmetic. A line to be clipped has a first end point and a second end point. Responsive to a determination that the line-clipping operation would likely be inaccurate, a line-fractioning operation is performed. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims. 37 CFR 1.72(b).

### CROSS-REFERENCE TO RELATED APPLICATIONS

This patent application claims priority from, and incorporates by reference the entire disclosure of, U.S. Provisional Patent Application No. 60/582,244, filed on Jun. 22, 2004 and bearing Attorney Docket No. 53807-00122USPL.

### BACKGROUND OF THE INVENTION

1. Technical Field

The present invention relates generally to line clipping in electronic devices and, more particularly, but not by way of limitation, to line clipping for actual or virtual displays of electronic devices utilizing fixed-point arithmetic.

2. History of Related Art

Floating-point calculations have typically been used in order to get accurate line clipping. In most applications, a line is clipped to fit an area which could be, for example, a display, which display is usually rectangular in shape. Such use of floating-point calculations often results in a high penalty on embedded devices due to lack of hardware support in the embedded devices for floating-point arithmetic.

In today's mobile electronic devices, software applications can be obtained (e.g., via download) from many different sources. These software applications may have the power to do various usual and unusual requests; one example is drawing extremely large geometrical primitives such as triangles and rectangles, which are usually built using lines. Such primitive drawing requires that a mobile-device platform on which the software application is executed properly handle all situations, whether they are ordinary or extraordinary. Such a software application could be written in, for example, JAVA.

When a line is clipped against a horizontal or vertical line, a simple formula is used. The formula typically includes a ratio a/(a+b), where, for example, a is a horizontal distance between a first end point of the line to be clipped and a vertical line against which the to-be-clipped line is to be clipped and b is a horizontal distance between a second end point of the line to be clipped and the vertical line against which the to-be-clipped line is to be clipped. The ratio is multiplied with, for example, a vertical distance c+d between the ends of the line to be clipped. When a fixed-point calculation is used and values used in the calculation are close to a maximal system representative integer that may be used, errors may result. Moreover, when a>>b or b>>a, a fixed-point calculation may result in calculation errors.

The Cohen-Sutherland algorithm may be used to perform initial tests on a line to determine whether intersection calculations can be avoided. When drawing a two-dimensional line, if one end point of the line is outside a display area of an electronic device and a second end point is inside the display area, the line must be clipped so that only the part of the line that is within the display area remains. Even if both end points are outside the display area, it is still possible that a part of the line is within the display area. A clipping algorithm must find new end points of the line that are either inside the display area or on the edges of the display area. The Cohen-Sutherland algorithm can be used to recognize whether or not line clipping is necessary.

### SUMMARY OF THE INVENTION

A line-clipping method includes determining whether a fixed-point-arithmetic line-clipping operation would likely be inaccurate due to limitations of fixed-point arithmetic. A line to be clipped has a first end point and a second end point. Responsive to a determination that the line-clipping operation would likely be inaccurate, a line-fractioning operation is performed.

An article of manufacture for line-clipping includes at least one computer readable medium and processor instructions contained on the at least one computer readable medium. The processor instructions are configured to be readable from the at least one computer readable medium by at least one processor and thereby cause the at least one processor to operate as to determine whether a fixed-point-arithmetic line-clipping operation would likely be inaccurate due to limitations of fixed-point arithmetic. A line to be clipped has a first end point and a second end point. Responsive to a determination that the line-clipping operation would likely be inaccurate, the processor instructions cause the at least one processor to operate as to perform a line-fractioning operation.

### BRIEF DESCRIPTION OF THE DRAWINGS

A more complete understanding of the present invention may be obtained by reference to the following Detailed Description of Exemplary Embodiments of the Invention, when taken in conjunction with the accompanying Drawings, wherein:

FIG. 1 is a graph that illustrates a line-clipping process;

FIG. 2 is a graph that illustrates a line-halving process;

FIG. 3 is a diagram that illustrates a Cohen Sutherland clip rectangle; and

FIG. 4 illustrates the Cohen Sutherland clip rectangle diagram of FIG. 3 with lines G₁M and L₁K illustrated thereon.

### DETAILED DESCRIPTION OF EXEMPLARY EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

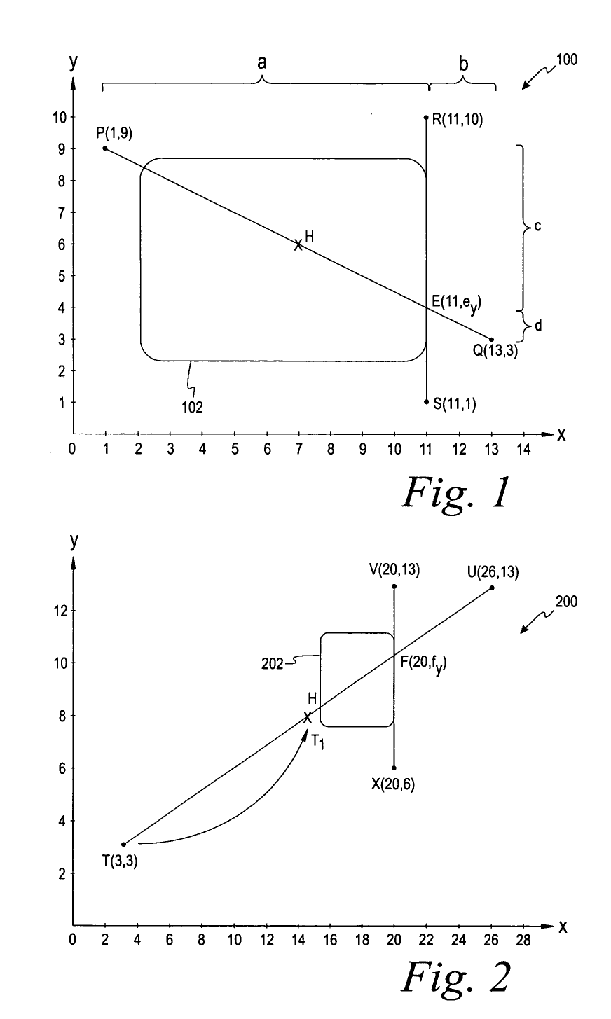

FIG. 1 is a graph that illustrates a line-clipping operation. A graph 100 includes a line PQ and a line SR. Also shown on FIG. 1 is a display area 102, the line PQ intersecting the display area 102. The line PQ is to be clipped at the point at which the line PQ intersects with the line SR and also at a second point at the upper left portion of the display area 102. For purposes of discussion, only the point at which the line PQ intersects the line SR will be described, although the point at which the line PQ is to be clipped at the upper left portion of the display area 102 will be understood to be determinable in an analogous fashion. A point of intersection E between the line PQ and the line SR is also shown. The abscissa and ordinate for each of the points P, Q, S, and R is known, as shown in the graph 100, while only the abscissa for point E is known, the ordinate of point E being indicated by e_{y}. Also indicated on the graph 100 are horizontal distances a and b, a being the horizontal distance (i.e., along the x axis) between point P and points S, R, and E, and b being the horizontal distance between points S, R, and E and point Q. In similar fashion, c represents the vertical distance (i.e., along the y axis) between point P and point E, while d represents the vertical distance between point Q and point E.

In order to determine the value of e_{y}, since the sum c+d is known, the following formula may be used:

$${e}_{y} = {P}_{y} - ( c + d ) \frac{a}{a + b} = 9 - ( 6 ) \frac{10}{12} = 9 - 5 = 4 \qquad ( 1 )$$

Thus, according to equation (1), the ordinate of point E is 4 (i.e., e_{y}=4). Thus, similar triangles may be used as illustrated above or in many analogous ways to determine the y intercept of lines PQ and SR. It will be appreciated by those having skill in the art that similar triangles may also be used to determine the intercept of a given line with any horizontal or vertical line.

The limited range in fixed-point calculations may result in inaccurate calculation results. The division a/(a+b) and multiplication involved in (c+d)(a/(a+b)) should generate an accurate result if the line-clipping operation is to be correct. By calculating a middle point, designated H in FIG. 1, where x and y coordinates of the middle point H are (Hₓ, H_{y}), respectively, and Hₓ=Pₓ+(Qₓ−Pₓ)/2 and H_{y}=P_{y}+(Q_{y}−P_{y})/2, the line can be halved and will still intersect the line SR. The line halving can be iterative until a≈b. Following the halving, calculation of the ratio a/(a+b) should be more accurate due to cancellation of large values (i.e., values that approach or exceed the maximal system representative integer). Once the accuracy of the ratio a/(a+b) has been achieved, calculation of (c+d)*(a/(a+b)) should also be more accurate.

Using line halving, an algorithm can be designed to work with a constant number of decimals in a fixed-point solution. The line to be clipped can hold end values that are within a range bounded by a minimal system representative integer value and a maximal system representative integer value. The line-halving process may result in additional time consumption; however, the line-halving operation is a relatively simple and quick algorithm. Its efficiency is even better when two line intersections can be obtained after a line has been halved, which is typically the case with a line that crosses a rectangular area. Moreover, no additional time is taken when values are initially in range (i.e., when no line halving is needed).

FIG. 2 is a graph that illustrates a line-halving process. A graph 200 is shown with x and y coordinates thereon. A display area 202 is also shown. A line TU is shown with end points T(3, 3) and U(26, 13). A vertical line VX is also shown, with end points V(20, 13) and X (20, 6). An intersection point F (20,f_{y}) between lines TU and VX is also shown, the abscissa of point F being 20 and the ordinate (i.e.,f_{y}) of point F being unknown and represented by f_{y}. The line TU intersects the display area 202 at two points, the point F and a second point in the lower left portion of the display area 202. For purposes of discussion, only the point F is discussed; however, it will be understood by those having skill in the art that the intersection point in the lower left portion of the display area 202 may also be determined in an analogous fashion. A floating-point calculation of f_{y} is as follows:

$${f}_{y} = {T}_{y} + ( {U}_{y} - {T}_{y} ) [ \frac{{X}_{x} - {T}_{x}}{{U}_{x} - {T}_{x}} ] = 3 + ( 13 - 3 ) ( \frac{20 - 3}{26 - 3} ) = 10.39130 \qquad ( 2 )$$

According to the calculation in equation (2) above, f_{y}=10.39130. However, if, for example, an 8 bit integer system using fixed-point arithmetic with a distribution of 4 integers (m)+4(n) decimals is used, a natural implementation using a binary system in order to attempt to get sufficient fixed-point accuracy, would be as indicated below:

$$\begin{matrix}{f}_{y} = {T}_{y} + \frac{( {U}_{y} - {T}_{y} ) [ \frac{{2}^{4} ( {X}_{x} - {T}_{x} )}{{U}_{x} - {T}_{x}} ]}{{2}^{4}} \\ = 3 + \frac{( 13 - 3 ) ( \frac{{2}^{4 } ( 20 - 3 )}{26 - 3} )}{{2}^{4}} \\ = 3.43 \approx 3\end{matrix} \qquad ( 3 )$$

In equation (3) above, multiplication with 2⁴ (i.e., 16) is equal to 4 left shift and division by 2⁴ (i.e., 16) is equal to 4 right shift in the binary system. More generally, multiplication by 2ⁿ is left shift by n bits and division by 2ⁿ is right shift by n bits. Thus, when, as shown above, equation (3) is used to obtain a value of f_{y}, the result is 3.43, which is truncated to 3. The result of equation (3) is erroneous are due to overflow, which occurs in the numerator 2⁴(20−3), which yields 16 rather than 272. This is because, in an 8 bit system, the maximal system representative integer is 255, which is less than 272. The error in calculation of f_{y} described above with respect to FIG. 2 may be avoided or minimized using line halving.

Also shown in graph 200 is a midpoint of line TU, which midpoint is designated H. Line halving of line TU may be performed as follows:

$$\begin{matrix}{H}_{x} = {T}_{x} + \frac{{U}_{x} - {T}_{x}}{2} = 3 + \frac{26 - 3}{2} = 14.5 \approx 14 & ( 4 ) \\ {H}_{y} = {T}_{y} + \frac{{U}_{y} - {T}_{y}}{2} = 3 + \frac{13 - 3}{2} = 8 & ( 5 )\end{matrix}$$

Thus, Hₓ equals 14.5, which, due to integer truncation, is set equal to 14. H_{y} is calculated to be 8. Since Hₓ is less than Xₓ, a new end point of line TU, termed T₁, is established, with an abscissa 14 and an ordinate 8. Reapplying equation (3) using T₁ (i.e., H) as the new end point (rather than T) yields equation (6) as follows:

$$\begin{matrix}{f}_{y} = {T}_{1 y} + \frac{( {U}_{y} - {T}_{1 y} ) [ \frac{{2}^{4} ( {X}_{x} - {T}_{1 x} )}{{U}_{x} - {T}_{1 x}} ]}{{2}^{4}} \\ = 3 + \frac{( 13 - 8 ) ( \frac{{2}^{4 } ( 20 - 14 )}{26 - 14} )}{{2}^{4}} \\ = 10.5 \approx 10\end{matrix} \qquad ( 6 )$$

Thus, f_{y} of the new line T₁U equals 10.5, with an integer-truncated result of 10, which is more accurate than the previous result of 3.43.

In various embodiments of the invention, where the total system bits=m (integer bits)+n (decimal bits), the longest distance (i.e., Uₓ−Tₓ or U_{y}−T_{y}) is halved until it is less than 2^{m} (and therefore multipliable with 2^{m}), which would be a pre-defined threshold thus multipliable with 2^{m}.

In the 8 bit system, the worst-case line length of 255 would be halved at most four times, which would yield an integer-truncated value of 15. Therefore, the line-halving operation would be performed in such a case no more than four times on an arbitrary line, which limit introduces minimal line-having-operation overhead.

Each of FIGS. 1 and 2 illustrates line clipping against a vertical line. However, it will be appreciated by those having skill in the art that principles of the invention may readily be applied to line-clipping operations performed against horizontal lines. It will also be appreciated by those having skill in the art that, although line-halving has been described hereinabove, the line need not necessarily be “halved” in order to be in accordance with the principles of the present invention. Rather, the line may be fractioned via multiplication by

$$\frac{1}{{2}^{z}} ,$$

where z is a positive integer, and the arithmetic suitably adjusted.

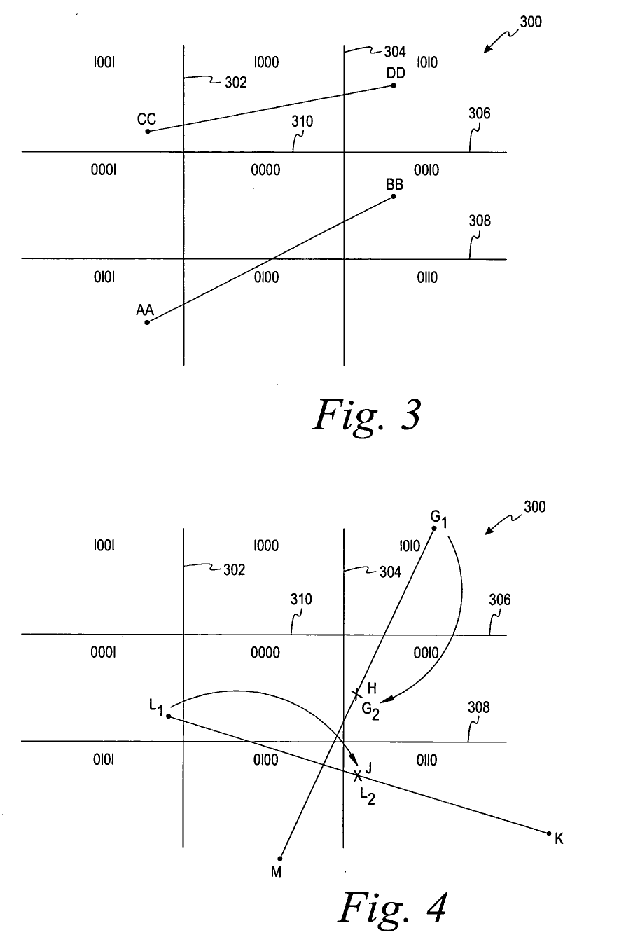

FIG. 3 illustrates a Cohen Sutherland clip rectangle. In many applications, a line is clipped to fit an area which could be, for example, a display, which display is usually rectangular in shape. The clip rectangle diagram 300 of FIG. 3 includes nine areas, which are numerically labeled 0000, 0001, 0010, 0100, 0101, 0110, 1000, 1001, and 1010, respectively. The numerical labels of the areas of the clip rectangle diagram 300 are typically referred to as field codes. Four clip lines 302-308 are shown defining the nine areas of the clip rectangle diagram 300. A clip rectangle 310 is formed by the lines 302-308, the clip rectangle 310 bearing the field code 0000. The Cohen Sutherland algorithm implies that, when bitwise anding of the field codes of two ends of a line yields zero, the line needs to be tested to determine if line clipping is necessary.

For example, when the field codes in which the end points CC and DD of line CCDD are bitwise anded (i.e., 1001 AND 1010=1000), the line CCDD is determined to not pass through the clip rectangle 310; therefore, the line CCDD does not need to be tested for line clipping. Similarly, when the field codes of the end points AA and BB of line AABB are bitwise anded (0101 AND 0010=0000), the line AABB is determined to pass through the clip rectangle 310 and therefore needs to be tested for line clipping.

Given the above, when a line is halved as described above, there may be, in some cases, a need to verify that a newly-calculated line end point is valid. In other words, there may be a need to verify whether the new end point results in a line that still intersects the clip rectangle 310 correctly. For example, if the line AABB were halved such that end points of the line were a midpoint HH and the point BB, verification that each of HH and BB is outside the clip rectangle 310 should be performed.

In order to ensure that a new end point formed by halving of a line results in a line that still crosses the clip rectangle 310, the following rules may be applied to determine whether use of halving to create a new line end point is valid:

1. Moves are valid when the field code is unchanged.

2. Moves are valid when a new field code differs from a previous field code in one bit only and the new field code is not 0000. (Rule 2 guarantees only one clip line crossing per line halving.)

FIG. 4 illustrates the Cohen Sutherland clip rectangle diagram 300 with lines G₁M and L₁K illustrated thereon. Shown on the line G₁M is a midpoint H, which becomes an end point G₂ of a line G₂M following a halving process. The halving process results in a valid move, since G₂ is not in the clip rectangle 310 (i.e., the field code in which G₂ is located is not 0000 and the field code 1010 of G₁ and 0010 of G₂ differ by only one bit).

Also shown on FIG. 4 is line L₁K. Shown on line L₁K is a midpoint J, which results from a halving operation, the halving operation resulting in a new line L₂K being created. The halving process performed on L₁K is not valid because the field code of L₁ (i.e., 0001) and the field code of L₂ (i.e., 0110) differ from one another by greater than one bit. (Upon a determination that the move from L₁ to L₂ is not valid, the algorithm would try to move K to J, which is a valid move.

Embodiments of the present invention may be implemented in, for example, hardware, software (e.g., carried out by a processor that executes computer-readable instructions), or a combination thereof. The computer-readable instructions may be program code loaded in a memory such as, for example, Random Access Memory (RAM), or from a storage medium such as, for example, Read Only Memory (ROM). For example, a processor may be operative to execute software adapted to perform a series of steps in accordance with principles of the present invention. The software may be adapted to reside upon a computer-readable medium such as, for example, a magnetic disc within a disc drive unit. The computer-readable medium may also include a flash memory card, EEROM based memory, bubble memory storage, ROM storage, etc. The software adapted to perform according to principles of the present invention may also reside, in whole or in part, in static or dynamic main memories or in firmware within a processor (e.g., within microcontroller, microprocessor, or a microcomputer internal memory).

The previous Detailed Description is of embodiment(s) of the invention. The scope of the invention should not necessarily be limited by this Description. The scope of the invention is instead defined by the following claims and the equivalents thereof.

1. A line-clipping method comprising:
determining whether a fixed-point-arithmetic line-clipping operation would likely be inaccurate due to limitations of fixed-point arithmetic;
wherein a line to be clipped has a first end point and a second end point; and
responsive to a determination that the line-clipping operation would likely be inaccurate, performing a line-fractioning operation.

2. The line-clipping method of claim 1, further comprising, following the step of performing the line-fractioning operation:
repeating the determining step;
responsive to a determination, from the step of repeating the determining step, that the line-clipping operation would likely be inaccurate, repeating the line-fractioning operation.

3. The line-clipping method of claim 1, wherein the step of determining whether the fixed-point-arithmetic line-clipping operation would likely be inaccurate comprises at least one of:
determining whether a quotient of a distance, along an axis, between the first end point of the line to be clipped and a line against which the line to be clipped is clipped and a distance between the second end point of the line to be clipped and the line against which the line to be clipped is clipped is outside a pre-defined range; and
determining whether a value to be used in the line-clipping operation exceeds a pre-defined threshold.

4. The line-clipping method of claim 1, wherein the step of determining whether the fixed-point-arithmetic line-clipping operation would likely be inaccurate comprises determining whether a difference between a distance, along an axis, between the first end point of the line to be clipped and a line against which the line to be clipped is clipped and a distance between the second end point of the line to be clipped and the line against which the line to be clipped is clipped exceeds a pre-defined threshold.

5. The line-clipping method of claim 1, wherein:
the step of determining whether the fixed-point-arithmetic line-clipping operation would likely be inaccurate comprises determining whether a value to be used in the line-clipping operation exceeds a pre-defined threshold; and
the pre-defined threshold is dependent on a maximal system representative integer for fixed-point calculations.

6. The line-clipping method of claim 1, wherein the line to be clipped is clipped against a vertical line.

7. The line-clipping method of claim 1, wherein the line to be clipped is clipped against a horizontal line.

8. The line-clipping method of claim 1, wherein the line-fractioning operation comprises:
subtracting an abscissa of the first end point from an abscissa of the second point to yield a first value;
dividing the first value by 2 to yield a second value;
adding the abscissa of the first end point to the second value;
subtracting an ordinate of the first end point from an ordinate of the second point to yield a third value;
dividing the third value by 2 to yield a fourth value; and
adding the ordinate of the first end point to the fourth value.

9. The line-clipping method of claim 8, wherein the steps are performed in the order listed.

10. The line-clipping method of claim 1, further comprising:
wherein the line-fractioning operation yields a midpoint of the line to be clipped; and
performing the fixed-point-arithmetic line-clipping operation, the fixed-operation comprising using the midpoint.

11. The line-clipping method of claim 1, further comprising:
wherein the line-fractioning operation yields a midpoint of the line to be clipped;
responsive to the step of performing the line-fractioning operation, determining whether the midpoint of the line to be clipped results in a line that crosses a clip rectangle;
responsive to a determination that the line to be clipped crosses the clip rectangle, performing the fixed-point-arithmetic line-clipping operation, the fixed-point-arithmetic line-clipping operation comprising using the midpoint.

12. The line-clipping method of claim 1, further comprising:
wherein the line-fractioning operation yields a midpoint of the line to be clipped;
responsive to the step of performing the line-fractioning operation, determining whether the midpoint of the line to be clipped results in a line that crosses a clip rectangle;
wherein the step of performing the line-fractioning operation comprises moving the first end point of the line to be clipped to the midpoint of the line to be clipped; and
responsive to a determination that the line to be clipped does not cross the clip rectangle, performing a second line-fractioning operation, the second line-fractioning operation comprising moving the second end point of the line to be clipped to the midpoint of the line to be clipped.

13. The line-clipping method of claim 12, wherein the step of moving the first end point of the line to be clipped to the midpoint of the line to be clipped is considered valid when a line between the midpoint and the second end point intersects the clip rectangle.

14. The line-clipping method of claim 13, wherein:
the line between the midpoint and the second end point intersects the clip rectangle if a field code of the midpoint is identical to a field code of the first end point; and
the line between the midpoint and the second end point intersects the clip rectangle if a field code of the midpoint differs from a field code of the first end point in one bit only and the field code of the midpoint is not 0000.

15. An article of manufacture for line-clipping, the article of manufacture comprising:
at least one computer readable medium;
processor instructions contained on the at least one computer readable medium, the processor instructions configured to be readable from the at least one computer readable medium by at least one processor and thereby cause the at least one processor to operate as to:
determine whether a fixed-point-arithmetic line-clipping operation would likely be inaccurate due to limitations of fixed-point arithmetic;
wherein a line to be clipped has a first end point and a second end point; and
responsive to a determination that the line-clipping operation would likely be inaccurate, perform a line-fractioning operation.

16. The article of manufacture of claim 15, the processor instructions further configured to cause the at least one processor to operate as to:
repeat the determining step; and
responsive to a determination from the repeat of the determining step that the line-clipping operation would likely be inaccurate, repeat the line-fractioning operation.

17. The article of manufacture of claim 15, wherein the processor instructions configured to cause the at least one processor to operate as to determine whether the fixed-point-arithmetic line-clipping operation would likely be inaccurate comprise processor instructions configured to cause the at least one processor to operate as to at least one of:
determine whether a quotient of a distance, along an axis, between the first end point of the line to be clipped and a line against which the line to be clipped is clipped and a distance between the second end point of the line to be clipped and the line against which the line to be clipped is clipped is outside a pre-defined range; and
determine whether a value to be used in the line-clipping operation exceeds a pre-defined threshold.

18. The article of manufacture of claim 15, wherein the processor instructions configured to cause the at least one processor to operate as to determine whether the fixed-point-arithmetic line-clipping operation would likely be inaccurate comprise processor instructions configured to cause the at least one processor to operate as to determine whether a difference between a distance, along an axis, between the first end point of the line to be clipped and a line against which the line to be clipped is clipped and a distance between the second end point of the line to be clipped and the line against which the line to be clipped is clipped exceeds a pre-defined threshold.

19. The article of manufacture of claim 15, wherein:
the processor instructions configured to cause the at least one processor to operate as to determine whether the fixed-point-arithmetic line-clipping operation would likely be inaccurate comprise processor instructions configured to cause the at least one processor to operate as to determine whether a value to be used in the line-clipping operation exceeds a pre-defined threshold; and
the pre-defined threshold is dependent on a maximal system representative integer for fixed-point calculations.

20. The article of manufacture of claim 15, wherein the line to be clipped is clipped against a vertical line.

21. The article of manufacture of claim 15, wherein the line to be clipped is clipped against a horizontal line.

22. The article of manufacture of claim 15, wherein the line-fractioning operation comprises:
subtracting an abscissa of the first end point from an abscissa of the second point to yield a first value;
dividing the first value by 2 to yield a second value;
adding the abscissa of the first end point to the second value;
subtracting an ordinate of the first end point from an ordinate of the second point to yield a third value;
dividing the third value by 2 to yield a fourth value; and
adding the ordinate of the first end point to the fourth value.

23. The article of manufacture of claim 22, wherein the processor instructions are configured to cause the at least one processor to operate as to perform steps in the order listed.

24. The article of manufacture of claim 15, further comprising:
wherein the line-fractioning operation yields a midpoint of the line to be clipped; and
processor instructions configured to cause the at least one processor to operate as to perform the fixed-point-arithmetic line-clipping operation, the fixed-operation comprising using the midpoint.

25. The article of manufacture of claim 15, further comprising:
wherein the line-fractioning operation yields a midpoint of the line to be clipped; and
processor instructions configured to cause the at least one processor to operate as to:
responsive to performing of the line-fractioning operation, determine whether the midpoint of the line to be clipped results in a line that crosses a clip rectangle; and
responsive to a determination that the line to be clipped crosses the clip rectangle, perform the fixed-point-arithmetic line-clipping operation, the fixed-point-arithmetic line-clipping operation comprising using the midpoint.

26. The article of manufacture of claim 15, further comprising:
wherein the line-fractioning operation yields a midpoint of the line to be clipped; and
processor instructions configured to cause the at least one processor to operate as to:
responsive to the step of performing the line-fractioning operation, determine whether the point of the line to be clipped results in a line that crosses a clip rectangle;
wherein the performing of the line-fractioning operation comprises moving the first end point of the line to be clipped to the midpoint of the line to be clipped; and
responsive to a determination that the line to be clipped does not cross the clip rectangle, perform a second line-fractioning operation, the second line-fractioning operation comprising moving the second end point of the line to be clipped to the midpoint of the line to be clipped.

27. The article of manufacture of claim 25, wherein the moving of the first end point of the line to be clipped to the midpoint of the line to be clipped is considered valid when a line between the midpoint and the second end point intersects the clip rectangle.

28. The article of manufacture of claim 26, wherein:
the line between the midpoint and the second end point intersects the clip rectangle if a field code of the midpoint is identical to a field code of the first end point; and
the line between the midpoint and the second end point intersects the clip rectangle if a field code of the midpoint differs from a field code of the first end point in one bit only and the field code of the midpoint is not 0000.

29. The article of manufacture of claim 15, wherein the at least one computer readable medium comprises at least one memory of a mobile telephone.
